(19) United States
(12) Patent Application Publication
(10) Pub. No.: US 2013/0088029 A1
(43) Pub. Date: Apr. 11, 2013

(54) HANDLING DEVICE FOR SUBSTRATES USING COMPRESSED AIR

(71) Applicant: Giordano Rocco, Mareno Di Piave (IT)

(72) Inventor: Giordano Rocco, Mareno Di Piave (IT)

(73) Assignee: APPLIED MATERIALS, INC., Santa Clara, CA (US)

(21) Appl. No.: 13/575,018

(22) PCT Filed: Jan. 26, 2011
(86) PCT No.: PCT/EP2011/051083

§ 371 Date: Dec. 20, 2012

(30) Foreign Application Priority Data
Jan. 27, 2010 (IT) UD2010A000014

(51) Int. Cl. B25J 15/06

(52) U.S. Cl. CPC B25J 15/0616
USPC 294/183

(57) ABSTRACT

Embodiments of the invention generally include a handling device that uses compressed air to grip and move substrates between different operating positions or work stations in a production line. The handling device comprises a gripping extremity shaped so as to define a hollow seating region in which a sub-atmospheric pressure is achieved, to cause an adjacently positioned substrate to be urged towards a reception element disposed near the hollow seating region. In some embodiments, the gripping extremity is shaped in a wing shaped profile, or substantially curvilinear, so as to make the air flow, which flows through the discharge apertures formed between the substrate, reception element and the gripping extremity, to be laminar.

### CROSS-REFERENCE TO RELATED APPLICATIONS

This application claims benefit of International Patent Application Serial No. PCT/EP2011/051083 filed Jan. 26, 2011, which claims the benefit of Italian Patent Application serial number UD2010A000014, filed Jan. 27, 2010, which are both herein incorporated by reference.

### BACKGROUND OF THE INVENTION

1. Field of the Invention

The present invention concerns a handling device using compressed air, that is configured to handle substrates used to form photovoltaic cells, multilayer printed circuits or, more generally, any electronic circuit.

In particular, the handling device according to the invention is used to support and hold a substrate by use of compressed air, based on the Bernoulli principle. Aspects of the invention can be used for gripping and moving the substrates, between different operating positions, for example between work stations of a production line making photovoltaic cells, such as in a screen printing, laser printing, ink jet printing or other similar line.

2. Description of Related Art

Handling devices that use vacuum, and the Bernoulli principal, to hold and move substrates to or within substrate processing stations found in a production line are known. The movement operations comprise for example gripping the substrates, moving them, stacking them, unloading them between processing stations, storage stations, conveyor belts or other similar devices.

Known handling devices comprise a gripping extremity, mobile by means of automatic movement members, associated with a reception element to receive the substrate disposed below said gripping extremity. The reception element, made for example of rubber or other similar material, is shaped according to a plane annular profile, for example circular, elliptic or other, having a predetermined thickness, and a plane contact portion disposed, during use, toward the substrate to be gripped.

The reception element is disposed so as to define a seating region in which a depression zone is made, or zone in which a sub atmospheric pressure zone is created, to attract the substrate to the reception element and to keep it attached stably to the contact portion. The gripping extremity is also provided with an air introduction pipe, in fluid communication with said seating region, through which compressed air is introduced at a predetermined pressure, and with one or more discharge apertures through which, when the substrate is about to adhere and subsequently does adhere to the reception element, the air introduced in the seating region emerges. In this way it is possible to achieve and maintain the desired conditions of low pressure, such as sub atmospheric pressure, so as to make the substrate adhere to the gripping element and to move it as desired.

One disadvantage of known handling devices that use vacuum to hold a substrate is that the attraction of the substrate to the gripping element is not controllable, since the acceleration with which the substrate approaches the reception element depends on the value of the vacuum pressure that is created in a region adjacent to the surface of the substrate. In conditions of very low vacuum pressure, that is of very low sub atmospheric pressure, the movement and an impact of the substrate against the reception element can be at too high a speed. Moreover, it is not always possible to obtain a controlled movement in terms of positioning of the substrate with respect to the reception element, which can lead to a contact of the substrate that is not spatially uniform. This can cause possible breakages, cracks or damage of the substrate or the cell, which cause an increase in working rejects and hence a reduction in the production capacity of the production line.

Furthermore, known handling devices function effectively only when the distance between the substrate and the handling device are small, which entails a need to accurately control the position and distance of the gripping element of the handling device with respect to the substrate during the process of retaining the substrate, and therefore increasing the substrate transfer times.

Another disadvantage with conventional Bernoulli devices is that, in order to keep the substrate stably associated with the reception element during its movement or during other working steps, a low pressure is made in a region adjacent to the substrate. This condition entails a stream of air at high speed between the introduction aperture and the discharge apertures which, in certain conditions, generates localized turbulence or cavitations able to produce unwanted vibrations or oscillations of the substrate during its adhesion to the handling device, increasing the probability of breakages in the fragile crystalline structure of the substrates.

One purpose of the present invention is to achieve a substrate handling device using compressed air which allows the substrate to be picked up, in a stable and secure manner, in a production line, preventing or minimizing breakages, damage or cracks in the transferred substrates.

Another purpose of the present invention is to achieve a substrate handling device using compressed air which can minimize the movement times and hence to improve the productive capacity of a production line for substrates.

Another purpose of the present invention is to achieve a substrate handling device using compressed air which has a low production cost.

The Applicant has devised, tested and embodied the present invention to overcome the shortcomings of the state of the art and to obtain these and other purposes and advantages.

### SUMMARY OF THE INVENTION

The present invention is set forth and characterized in the independent claim, while the dependent claims describe other characteristics of the invention or variants to the main inventive idea.

In accordance with the above purposes, a handling device using compressed air according to the invention is used to grip and move substrates, or wafers, comprising, for example, silicon containing materials, ceramic materials or plastic materials, between different operating positions or work stations of a production line, for example of photovoltaic cells.

The handling device comprises a gripping extremity shaped so as to define a hollow seating region disposed, during use, towards the substrate to be handled, in which a sub-atmospheric pressure is achieved, which causes the substrate to be urged towards the hollow seating region.

The handling device comprises at least a reception element for the substrate, associated with the gripping extremity, disposed in cooperation with said hollow seating region, defining a contact surface on which the substrate rests when it adheres to the device.

The gripping extremity is also provided with an air introduction aperture, in fluid communication with the hollow seating region, through which compressed air is introduced, and one or more discharge apertures through which, when the substrate is about to adhere and subsequently does adhere to the reception element, the air introduced in the hollow seating region emerges.

According to a feature of the present invention, the reception element is mobile with respect to the gripping extremity by means of first position adjustment means, so as to move the reception element with respect to the hollow seating region, by use of adjustable discharge apertures disposed, or gap formed, between the reception element and the gripping element. In this way, it is always possible to obtain a desirable sub-atmospheric pressure to grip a substrate by adjusting both the zone in which the sub-atmospheric pressure is concentrated in the hollow seating region, and also the gap of the discharge apertures, depending for example on the specific type of substrates to be handled, that is, their actual weight and/or size.

According to a variant of the present invention, in correspondence with said hollow seating region the gripping extremity is shaped in a wing shaped profile, substantially curvilinear, so as to make the air flow towards the discharge apertures laminar, so as to cause the flowing air to follow the wing shaped profile. In this way the air introduced into the hollow seating emerges through the discharge apertures in a controlled manner, preventing unwanted turbulence or cavitation and hence unwanted oscillations and vibrations of the substrate when it is retained by the handling device. Furthermore, the positioning of the handling device with respect to the substrates to be moved is quicker than in the current state of the art devices, given the greater efficiency of the device because it is not necessary to always position it within a limited and predetermined distance with respect to the substrate to be moved.

According to another variant of the present invention, the handling device comprises an interception element, coupled with the gripping extremity and disposed in cooperation with said hollow seating region and said air introduction aperture. The interception element is shaped to mate with said wing shaped profile so as to define therewith an opening, to control the speed at which the compressed air exits from the hollow seating region. In this way it is possible to increase or decrease the air exit speed, promoting a flow into the hollow seating region and onto the wing shaped profile that is laminar, to obtain a desirable negative pressure in the hollow seating region.

A variant of the present invention provides that the handling device comprises second adjustment means, or second adjustment device, associated with the interception element, that is able to adjust the position of the interception element with respect to the hollow seating region, from an inactive position corresponding to a predetermined open or closed condition of the emission opening. In this way, by modifying the gap of the opening, that is, the position of the interception element with respect to the wing shaped profile of the hollow seating region, it is possible to control the speed of the air flow, so as to keep it in a laminar condition according to the actual value of the pressure at the inlet to the introduction pipe.

According to another variant of the invention the interception element is adjustable to at least an extra-emission position, due to the effect of the thrust of the air introduced into the hollow seating region, causing an increase in the gap of the opening. The interception element is also contrasted in said movement from the inactive position to the extra-emission position by means of an elastic element associated with the interception element and able to return the interception element to its inactive position.

In this way, apart from adjusting the inactive position of the interception element, that is, the gap of the opening, it is possible to modify the aperture of the opening dynamically and according to the introduction pressure of the air. This entails a further and more precise adjustment of the speed of laminar flow of the air, allowing to control dynamically the sub-atmospheric pressure generated in the hollow seating region and therefore to create a lower working pressure that can attract the substrate towards the reception element at a speed such as to prevent cracks or breakages in the often fragile substrates, such as solar cell type substrates.

A variant of the invention provides that the second adjustment means are also associated with the elastic element, so that the adjustment of the inactive position allows their elastic response to be adjusted, and thus vary the amount of force applied to the interception element by the elastic element. In this way it is possible to further modify the dynamic range of the interception element with respect to the inactive position, for example by increasing the counteracting resistance, or applied force, created by the elastic element if high pressure is delivered to the space between interception element and the gripping extremity (e.g., gripping disk).

Another variant of the present invention provides that said hollow seating region comprises an expansion compartment to distribute the air uniformly, for example annularly, and to equalize the air pressure in the introduction aperture so as to prevent the initiation of pulsating conditions and undesirable overpressurization conditions.

Embodiments of the present invention may further provide a handling device for gripping substrates, comprising a gripping disk having a first surface that is radially symmetric about a first axis, an annular reception support disposed over the first surface of the gripping disk, and having a substrate contact surface and second surface, wherein one or more discharge apertures are formed between the first surface of the gripping disk and the second surface of the annular reception support, and one or more position adjustment devices that are in contact with the gripping disk and the reception support, wherein the position of the one or more position adjustment devices relative to the gripping disk is adjustable to adjust the size of the one or more discharge apertures.

Embodiments of the present invention may further provide a handling device for gripping substrates, comprising a gripping disk having a first surface, a support disposed over the first surface of the gripping disk, and having a substrate contact surface and second surface, wherein a gap is formed between the first surface of the gripping disk and the second surface of the reception support, and one or more position adjustment devices that are in contact with the gripping disk and the support, wherein the position of the one or more position adjustment devices relative to the gripping disk is adjustable to adjust the size of the formed gap. The handling device may also comprise a gripping disk that has a first surface that has a wing shaped profile so as to provide a laminar gas flow through the formed gaps (e.g., one or more discharge apertures), wherein the gas flow is delivered from a gas source that is fluidly coupled to a seating region, which is at least partially defined by the first surface of the gripping disk and surrounds at least a portion of an axis of symmetry of the gripping disk.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a perspective view of a processing system that uses a handling device using compressed air according to the present invention;

FIG. 2 is a schematic plan view of the system shown in FIG. 1;

FIG. 3 is a lateral view of the handling device according to the present invention;

FIG. 4 is a schematic lateral view of the device in FIG. 3 according to the present invention;

FIG. 5 is a view from above of FIG. 4 according to the present invention;

FIG. 6 is a perspective view of the device in FIGS. 4 and 5 according to the present invention;

FIG. 7 is a front view of the handling device in FIG. 4 according to the present invention; and

FIG. 8 is a cross-sectional view created by use of a sectioning line extending from VIII to VIII in FIG. 4 according to the present invention.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

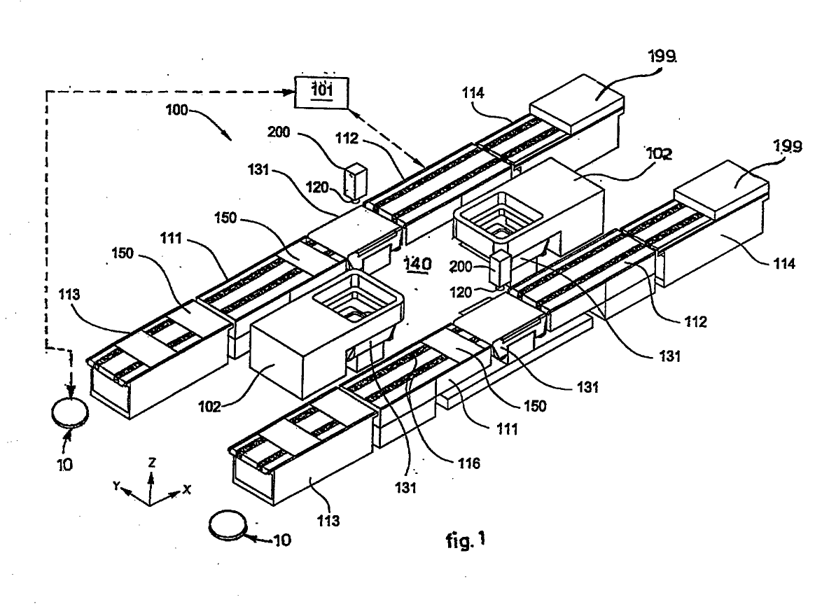

With reference to the FIGS. 1-3, a handling device 10 for positioning substrates using compressed air according to the present invention is used to quickly grip and transfer substrates 150, for example, in a substrate processing system, or system 100.

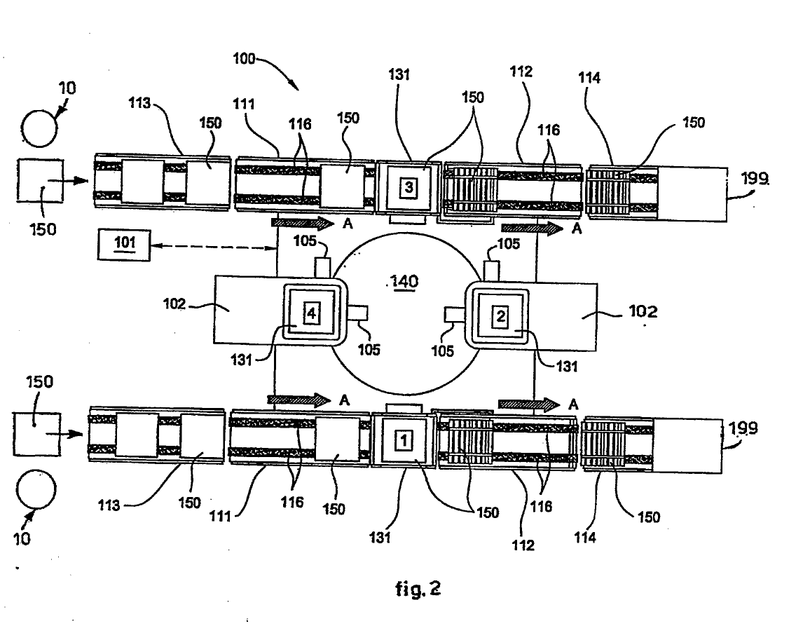

In FIGS. 1 and 2, the system 100 shown is a printing system for printing a print material, such as a conductive paste material, on the substrates 150, in order to form conductor tracks on the substrates 150. In some cases, the substrates 150 may be plate type elements used in electronic devices or the like, for example silicon based wafers to make photovoltaic cells.

FIG. 1 is a perspective view of the system 100. In one embodiment, the system 100 comprises generally two incoming conveyors 111, an actuator assembly 140, a plurality of processing nests 131, a plurality of print heads 102, two outgoing conveyors 112 and a system controller 101.

The incoming conveyors 111 are configured in a parallel working configuration so that each can receive unprocessed substrates 150 from an input device, such as an input conveyor 113, and transfer each unprocessed substrate 150 to a processing nest 131 coupled to the actuator assembly 140. Also, the outgoing conveyors 112 are configured in parallel so that each can receive a processed substrate 150 from a processing nest 131 and transfer each processed substrate 150 to a substrate removal device, such as an exit conveyor 114.

In one embodiment, each exit conveyor 114 is able to transport the processed substrates 150 through an oven 199 so as to thermally process the material deposited on the substrate 150 by the print heads 102.

In one embodiment, the substrates 150 are substrates formed from a microcrystalline silicon material used for processing solar cells thereon. In another embodiment, the substrates 150 are green tape ceramic substrates or similar.

In one embodiment of the present invention, the system 100 is a screen printing processing system which includes screen printing components that are configured to screen print a layer according to a pattern of material on a substrate 150. In another embodiment, the system 100 is a processing system that includes material removal components, such as a laser, to remove or engrave one or more regions of a substrate 150. In other embodiments, the system 100 can comprise other substrate processing modules which require movement and accurate positioning of the substrates for processing.

The handling device 10 according to the present invention is used for transferring the substrates 150 from a previous processing step to the screen printing devices found in system 100. For example, the handling device 10 is configured to transfer the substrates 150 from a storage zone to the input conveyors 113, or to pick up the substrates 150 from the ovens 199 and to transfer them to a subsequent processing step or for storage in a subsequent storage station. The device or handling devices 10 are connected to the system controller 101 so as to achieve a movement of the substrates 150 in a coordinated manner with the current processing cycle or cycles.

FIG. 2 is a schematic plan view of the system 100 shown in FIG. 1. FIGS. 1 and 2 illustrate a configuration of system 100 that has two processing nests 131 (in positions “1” and “3”), each positioned both to transfer a processed substrate 150 toward the outgoing conveyor 112 and also to receive an unprocessed substrate 150 from the incoming conveyor 111.

In this way, in the system 100, the movement of the substrates 150 generally follows the pathway “A” shown in FIGS. 1 and 2. In this configuration, each of the other two processing nests 131 (in positions “2” and “4”) is positioned under a print head 102, so that the unprocessed substrates 150 located on the respective processing nests 131 can be processed (e.g., screen printing process). This parallel processing configuration allows an increased productive capacity while minimizing the processing system size. Although the system 100 is shown with two print heads 102 and four processing nests 131, the system 100 can comprise additional print heads 102 and/or processing nests 131 without departing from the scope of the present invention.

In one embodiment, the incoming conveyor 111 and the outgoing conveyor 112 comprise at least a belt 116 to support and transport the substrates 150 toward a desired position in the system 100 using an actuator (not shown) which is in communication with the system controller 101. Although FIGS. 1 and 2 generally show a substrate transfer system of the type with two belts, other types of transfer mechanisms can be used to perform the same substrate transfer and positioning functions without departing from the main purpose of the invention.

In one embodiment, the system 100 also includes an inspection system 200 which is suitable to identify and inspect the substrates 150 before and after processing has been carried out. The inspection system 200 may include one or more cameras 120 which are positioned to inspect a substrate 150, positioned in the loading/unloading positions “1” and “3”, as shown in FIGS. 1 and 2.

The inspection system 200 includes generally at least one camera 120 (e.g., CCD camera) and other electronic components capable of identifying, inspecting and communicating the results to the system controller 101. In one embodiment, the inspection system 200 identifies the position of certain characteristics of an incoming substrate 150 and communicates the results of the inspection to the system controller 101 to analyze the orientation and position of the substrate 150 so as to assist in the precise positioning of the substrate 150 under a print head 102 before carrying out the processing of the substrate 150.

In one embodiment, the inspection system 200 inspects the substrates 150 so that damaged or poorly processed substrates can be removed from the production line. In one embodiment, each processing nest 131 can contain a lamp, or other similar optical radiation device, to illuminate the substrate 150 positioned thereon, so that it can be inspected more easily by the inspection system 200.

The system controller 101 facilitates the control and automation of the overall system 100 and may include a central processing unit (CPU) (not shown), memory (not shown), and support circuits (or I/O) (not shown). The CPU may be one of any form of computer processors that are used in industrial settings for controlling various chamber processes and hardware (e.g., conveyors, detectors, motors, fluid delivery hardware, etc.) and monitor the system and chamber processes (e.g., substrate position, process time, detector signal, etc.). The memory is connected to the CPU, and may be one or more of a readily available memory, such as random access memory (RAM), read only memory (ROM), floppy disk, hard disk, or any other form of digital storage, local or remote.

Software instructions and data can be coded and stored within the memory for instructing the CPU. The support circuits are also connected to the CPU for supporting the processor in a conventional manner. The support circuits may include cache, power supplies, clock circuits, input/output circuitry, subsystems, and the like. A program (or computer instructions) readable by the system controller 101 determines which tasks are performable on a substrate. Preferably, the program is software readable by the system controller 101, which includes a code to generate and store at least substrate positional information, the sequence of movement of the various controlled components, substrate inspection system information, and any combination thereof.

In one embodiment, the two printing heads 102 used in system 100 can be conventional screen printing heads available from Applied Materials Baccini S.p.A., which are suitable to deposit material in a desired pattern on the surface of a substrate 150 positioned on a processing nest 131 in position “2” or “4” during the screen printing process. In one embodiment, the printing head 102 comprises a plurality of actuators, for example, actuators 105 (e.g., stepper motors, servo-motors) that are in communication with the system controller 101 and are used to adjust the position and/or angular orientation of the printing net, or a screen printing mask (not shown in FIGS. 1 and 2) disposed in the print head 102 with respect to the substrate 150 that is printed.

In one embodiment, the screen printing mask is a metal foil or metal plate (for example made of stainless steel) with a plurality of holes, slits or other apertures made between them so as to define a pattern of the material printed on a surface of a substrate 150. In one embodiment, the screen printed material can comprise an ink or a conductive paste, a doping gel, an engraving gel one or more masking materials, or other conductor or dielectric materials.

In general, the screen printed pattern that has to be deposited on the surface of a substrate 150 is aligned with the substrate 150 automatically, orienting the screen printing mask using the actuators 105 and the information received by the system controller 101 from the inspection system 200. In one embodiment, the printing heads 102 are suitable to deposit a metal containing or dielectric containing material on the solar cell substrate 150, which has a width between about 125 mm and about 156 mm and a length between about 70 mm and about 156 mm.

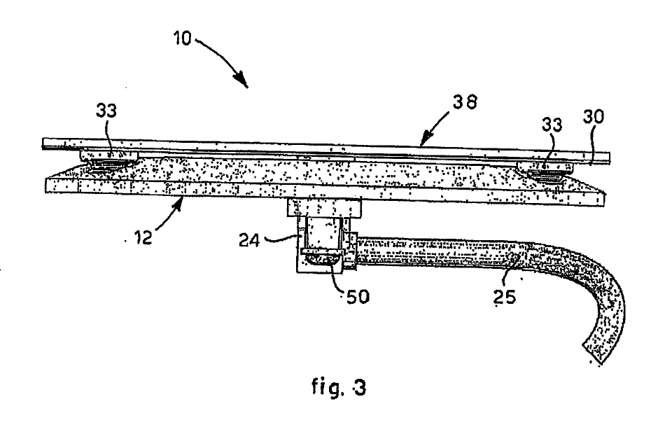

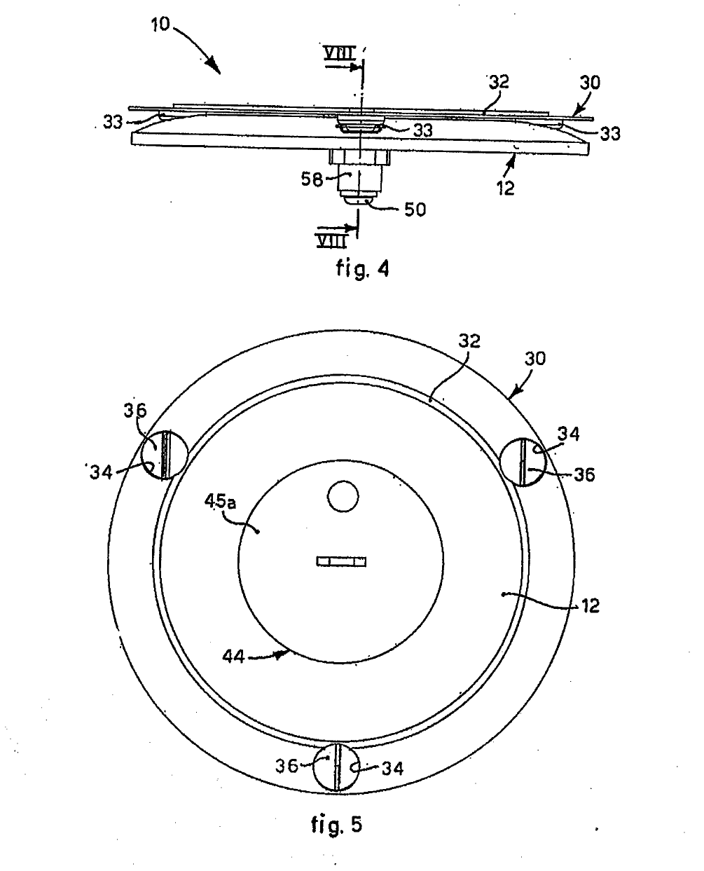

With reference to FIGS. 3-8, the handling device 10 according to one embodiment of the present invention comprises a gripping disk 12, provided with an air introduction inlet 24, a reception support 30, coupled with the gripping disk 12, and an interception cone 44 (FIGS. 5-6 and 8), also coupled with the gripping disk 12. In one embodiment, the device 10 comprises positioning adjustment devices, or first adjustment screws 36, to attach and adjust the position of the reception support 30, and a second adjustment device, or second adjustment screw 50, that is used to adjust the position of the interception cone 44 with respect to the gripping disk 12.

The gripping disk 12, the reception support 30 and the interception cone 44 are made, for example, of a plastic material having a rigidity such as to support the stresses applied. In some embodiments, the gripping disk 12, the reception support 30 and the interception cone 44 can also be made of metal material, such as aluminum, so as to be able to function in particular types of atmospheres, for example, corrosive, high temperature or other environments.

The gripping disk 12 has a substantially circular, or annular, shape and is provided with a front surface disposed, during use, towards the substrate 150 to be picked up or handled. The surface is shaped as a wing shaped curvilinear profile, substantially convex, having a peak portion 12a having the maximum convexity in correspondence with an intermediate diameter of the gripping disk 12, and portions respectively sloping down toward the central part and toward the peripheral edge of the gripping disk 12. In one configuration, the gripping disk 12 is axially symmetric, such as symmetric about an axis “X” passing through the center of the gripping disk 12.

In one configuration, the wing shaped profile of the gripping disk 12 is radially symmetrical, relative to the axis of symmetry “X” passing through the center of the gripping disk 12, so as to define, in correspondence with the central part of the gripping disk 12, a hollow seating region 13 that is disposed adjacent to a substrate when in use. A low pressure condition, which is a sub atmospheric pressure or negative pressure condition, is made in the hollow seating region 13, which allows the substrate 150 to be urged towards the reception support 30, so that it can be adhered thereto. Furthermore, the hollow seating region 13 is suitable to cooperate with the interception cone 44, or also referred to as the interception element 44, as will be explained hereafter in more detail.

The central part of the gripping disk 12 provides a chamber region 14 on the bottom surface 15 into which the introduction inlet 24 opens, so as to define an annular expansion and distribution compartment for the air introduced therein. This allows one to avoid the initiation of gas pressure pulsation and local regions where undesirable overpressurization conditions can occur in the hollow seating region 13.

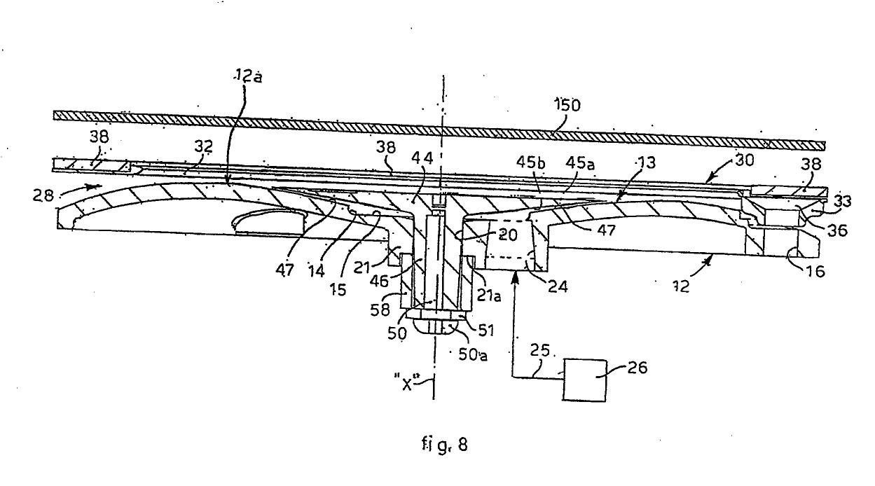

In the bottom surface 15 (FIG. 8), an aperture 20 having a cylindrical shape is made, that is able to cooperate with the interception cone 44, and functioning as a support and a sliding guide. The aperture 20 extends from the chamber region 14 along a rear protrusion 21 of the gripping disk 12. The rear protrusion 21 is provided with a contrasting portion 21 that has a greater diameter than the aperture 20.

The gripping disk 12 also comprises three first holes 16 (e.g., one shown in FIG. 8) formed through its opposite surfaces and disposed on the peripheral edge, equidistant by about 120° one from the other. Each of the first holes 16 allow the insertion of a first screw 36 to attach and adjust the position of the reception support 30, as will be described hereafter.

The air introduction inlet 24 is disposed on a surface opposite the front surface of the gripping disk 12, thus allowing the hollow seating region 13 to be in fluid communication with the air introduction inlet 24. In one configuration the air introduction inlet 24 is fluidly coupled to an air introduction pipe 25 and a device 26, which are used to deliver compressed air at a desired pressure.

The reception support 30, for example made of the same material as the gripping disk 12, is shaped like a plane circular crown, the external diameter of which is substantially equal to the diameter of the gripping disk 12 and its width in the radial direction is fixed relative to the position of maximum convexity of the wing shaped profile of the gripping disk 12. The reception support 30 is mechanically coupled with the gripping disk 12 and is disposed concentrically and parallel thereto, and thus has a desired spatial relationship with the hollow seating region 13. The reception support 30 is positioned with respect to the gripping disk 12 so as to define a gap or discharge aperture 28 for the air delivered from the device 26.

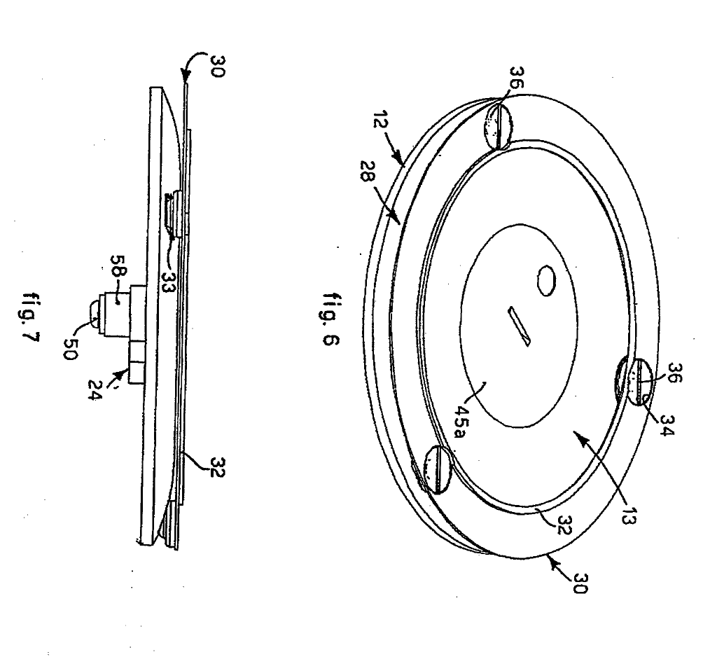

The reception support 30 comprises support columns 33 which protrude towards the gripping disk 12 and are disposed equidistant by about 120° from each other. Each support column 33 comprises second through holes 34 (FIGS. 5-6), which are the same size as the first holes 16 formed in the gripping disk 12. When the reception support 30 and the gripping disk 12 are adjacently disposed, the first screws 36 are inserted into the second through hole 34, so as to assemble and to stably support the reception support 30 to the gripping disk 12. The first screws 36 also allow the adjustment of the relative position of reception support 30 to the gripping disk 12 by the adjustment of the first screw 36 relative to the reception support 30 (e.g., threading the screw in or out of the reception support or gripping disk) and/or by inserting or removing spacers, or other suitable gap controlling elements (e.g., washers), in a gap formed between a surface of the gripping disk 12 and the support columns 33. This configuration, allows the modification of the thickness of the discharge gap or aperture 28, and hence allows one to modify, during use, the low pressure, or sub atmospheric or negative pressure, formed in the hollow seating region 13 by the delivery of the compressed air from the device 26.

The reception support 30 also comprises a guide ridge 32 (FIG. 8) for a packing 38, made along its entire internal perimeter, shaped according to the mouth of a wing shaped profile. The ridge 32 cooperates with an internal edge of the packing 38, and is made of a soft material, so as not to damage the handled substrate. The packing 38 also has a thickness slightly greater than the ridge 32, and is generally shaped like an annular crown having the same external diameter as the support 30. The packing 38 therefore defines a contact surface for the substrates 150, when the substrate is being transferred.

According to one embodiment, the packing 38 is substantially flat so as to allow an effective contact with a flat surface of the substrates 150 that are to be handled.

In another embodiment the packing 38 has an at least partly concave transverse profile, for example spherical or cylindrical, so as to allow a desirable grip and contact to be formed between the packing 38 and different kinds of substrates that may have at least a partial spherical or cylindrical shape. In such embodiments, the wing shaped profile of the gripping disk 12 is also shaped in a manner mating with the profile of the packing 38 so as to always obtain effective conditions of adhesion of the substrates to the handling device 10.

The interception cone 44, which is partly disposed in the hollow seating region 13, comprises a conical portion 45, provided with a plane base 45a, disposed toward the reception support 30, and with a lateral surface 45b having a curvilinear profile mating with the wing shaped profile of the gripping disk 12.

The interception cone 44 is also provided with a mating feature, or cylindrical rod 46, that is connected to the conical portion 45, and has an axis that is coincident with the axis “X” during use. The rod 46 is slightly smaller in size than the diameter of the aperture 20, so as to allow it to slide axially within the aperture 20. The interception cone 44 is therefore aligned and moveable along the axis “X” (FIG. 8) due to the effect of the thrust of compressed air entering from the inlet 24 and hitting a portion of lateral surface 45b. In one configuration, the symmetric shape, such as cylindrical shape of the aperture 20 and/or rod 46 constrains the linear movement of the interception cone 44 relative to the gripping disk 12 to a direction that is parallel to the axis of the cylindrical shape. For example, the rod 46 is constrained by aperture 20 so that the interception cone 44 is restrained to move relative to the gripping disk 12 in a direction parallel to the axis “X”.

The axial displacement of the cone 44 determines the formation of an emission aperture or opening 47, which is interposed between the surface of the gripping disk 12 and the lateral surface 45b of the interception cone 44, that has a radial shape determined by the wing shaped profile of the gripping disk 12 and by the mating profile of the cone 44. During use, the opening 47 has a variable gap according to the inlet pressure of the air delivered from a fluid source, such as device 26.

On the base 45a of the cone 44 a rectangular through central seating region is also formed to counteract the action of a screwdriver when the second screw 50 is screwed in.

The rod 46 is also provided with a holed seating region, which is formed longitudinally, and into which the second adjustment screw 50 is inserted. The second adjustment screw 50 can be used to adjust an inactive position of the interception cone 44 with respect to the gripping disk 12, by use of an elastic tubular element 58, which is described further below.

The elastic tubular element 58, for example made of silicone material, surrounds one end of the rod 46 and is positioned between a head 50a of the screw 50 and the contrast portion 21a of the gripping disk 12. The elastic tubular element 58, may also be positioned between a washer 51 coupled with the head 50a and the contrast portion 21a of the gripping disk 12. The elastic tubular element 58 is configured to exert a contrasting action, or resisting force, that acts against the dynamic displacement of the interception cone 44 relative to the gripping disk 12 produced by the pressure of the air introduced through the inlet 24, and also functions as a pneumatic sealing element at the lower end of the rod 46.

The adjustment screw 50 therefore allows one to adjust the inactive position of the interception cone 44 in the hollow seating region 13, by modifying the size of the opening 47 formed between the interception cone 44 and the surface of gripping disk 12. In one example, the opening 47 has a zero gap formed between the surface of the disk and the lateral surface 45b. In this configuration, the lateral surface 45b is disposed substantially in contact with the wing shaped profile of the gripping disk 12.

In this way, by modifying the gap of the opening 47, that is, the position of the interception cone 44 with respect to the wing shaped profile of the hollow seating region 13, it is possible to control the speed of the air flow, so as to keep it in a laminar condition according to the actual value of the pressure supplied at the inlet 24.

The adjustment of the screw 50 also allows one to adjust the compression or non-compression on the elastic tubular element 58, so as to modify its actual elastic response. In this way it is possible to further modify the dynamic range of the interception cone 44 with respect to the inactive position, for example by increasing the contrast resistance, resisting force, delivered by the elastic tubular element 58 if high gas operating pressures are provided at the inlet 24.

The handling device 10 as described heretofore functions and is tuned as generally described below.

The tuning of the device 10, for example according to the weight and actual sizes of the substrates 150 to be handled and moved during the transferring steps, can be adjusted by means of the adjusting the position of the first screws 36 relative to the gripping disk 12. Therefore, the position of the reception support 30, that is, its movement toward or away from the gripping disk 12, and hence the relative widening or narrowing of the discharge aperture 28 can be adjusted and controlled. It is therefore possible to obtain a desirable low pressure, or sub atmospheric or negative pressure, to grip a substrate by adjusting both the zone where the low pressure is concentrated in the hollow seating region 13, and also the gap of the discharge apertures 28.

The tuning process may also include the adjustment of the inactive position of the interception cone 44 by the adjustment of the position of the screw 50 relative to the rod 46. This adjustment allows one to dispose the cone 44 in a predetermined position in the hollow seating region 13, so as to define a desired size of the opening 47 through which the compressed air flows.

In this way, the compressed air flow through the device is always controlled, and also allows one to adjust and guarantee that the flow through the discharge aperture 28 has a substantially laminar flow. As noted above the creation of laminar flow allows the flowing gas to adhere to the wing shaped profile of the gripping disk 12. Laminar flow thus prevents the formation of unwanted wake or stalling turbulences or cavitations in the gas flow, and therefore, when the substrate 150 is disposed on the reception support 30, preventing bending or flexing oscillations and vibrations of the substrate 150 when it is retained on the handling device 10.

By adjusting the second screw 50 it is also possible to modify the elastic response of the elastic tubular element 58, and hence to vary the inactive position of the interception cone 44 depending on the pressure of the air introduced into the hollow seating region 13. The force applied to the inception cone 44 by the elastic tubular element 58 is proportional to the supplied inlet pressure. This allows one to adjust the maximum displacement range of the interception cone 44 with respect to its inactive position, by adjusting the compression or deflection of the tubular element 58.

Moreover, the adjustment of the introduction pressure of the air into the hollow seating region 13, or the compensation chamber, depending on the specific adjustment of the second screw 50 position relative to the rod 46 allows one to obtain dynamically, and with the desired accuracy, conditions where the air emerging always is laminar, due to the winged curvilinear profile of the gripping disk 12, and hence the pressure in the hollow seating region 13 is dynamically controllable.

In this way it is therefore possible to exert a controlled attraction of the substrate 150 to the handling device 10, to avoid high accelerations and impact forces created when the substrate 150 contacts the packing 38 of the reception support 30.

Furthermore, by controlling the outlet flow of air, so that it is always laminar, it is possible to keep the substrate 150 against the reception support 30 and assure that the applied low pressure is not too high, which can further reduce the probability of damaging or cracking the fragile crystalline structure of the substrates 150 that are typically used to form solar cell devices.

It is clear that modifications and/or additions of parts may be made to the handling device 10 as described heretofore, without departing from the field and scope of the present invention.

It is also clear that, although the present invention has been described with reference to some specific examples, a person of skill in the art shall certainly be able to achieve many other equivalent forms of handling device 10, having the characteristics as set forth in the claims and hence all coming within the field of protection defined thereby.

1. A handling device for gripping substrates, comprising:
a gripping disk having a first surface;
a support disposed over the first surface of the gripping disk, and having a substrate contact surface and a second surface, wherein a gap is formed between the first surface of the gripping disk and the second surface of the support; and
one or more position adjustment devices that are in contact with the gripping disk and the support, wherein the position of the one or more position adjustment devices relative to the gripping disk is adjustable to adjust the size of the formed gap.

2. The handling device of claim 1, further comprising:
an interception element having a surface that mates with the first surface of the gripping disk, and a mating feature that is slidably engaged with a portion of the gripping disk.

3. The handling device of claim 2, wherein the first surface of the gripping disk and the surface of the interception element are both symmetric about a first axis.

4. The handling device of claim 2, wherein the first surface of the gripping disk has a wing shaped profile and the surface of the interception element has a curvilinear profile, which is configured to mate with at least a portion of the first surface.

5. The handling device of claim 1, further comprising:
an interception element having a mating feature that is engaged with a portion of the gripping disk so that the interception element is constrained to move relative to the gripping disk in a direction parallel to a first direction; and
an elastic element disposed between the interception element and the gripping disk, and configured to supply a force to the gripping disk and the interception element that is proportional to the displacement of the interception element relative to the gripping disk along the first direction.

6. The handling device of claim 5, wherein the elastic element comprises a silicon material.

7. The handling device of claim 1, further comprising:
an interception element having a lateral surface and a mating feature which is slidably engaged with a portion of the gripping disk; and
an adjustment device coupled to the interception element, wherein the adjustment device is able to adjust the position of the lateral surface of the interception element with respect to the first surface of the gripping disk.

8. The handling device of claim 7, further comprising:
an elastic element disposed between the adjustment device and the gripping disk, and configured to supply a force to the gripping disk and the interception element that is proportional to the displacement of the lateral surface of the interception element relative to the first surface of the gripping disk.

9. The handling device of claim 1, wherein the first surface has a wing shaped profile so as to provide a laminar gas flow through the formed gap, and wherein the flow of gas is delivered from a gas source that is fluidly coupled to a seating region which is at least partially defined by the first surface of the gripping disk and surrounds at least a portion of an axis of symmetry of the gripping disk.

10. The handling device of claim 1, wherein the first surface has a wing shaped profile having a portion of maximum convexity in correspondence with an intermediate diameter of the gripping disk, and additional portions that slope away from the maximum convexity towards a central part and towards a peripheral edge of the gripping disk.

11. The handling device of claim 1, wherein the substrate contact surface is planar.

12. The handling device of claim 1, wherein the substrate contact surface is at least partially concave in a vertical direction.

13. The handling device of claim 1, further comprising:
an interception element having a mating feature that is slidably engaged with a portion of the gripping disk;
an elastic element disposed between the interception element and the gripping disk; and
a gas source configured to supply a gas at a varying pressure to a space formed between a surface of the interception element and the first surface of the gripping disk, wherein a gap formed between the surface of the interception element and the first surface of the gripping disk is adjustable by controlling the pressure of the gas supplied to the gap.

14. A handling device for gripping substrates, comprising:
a gripping disk having a first surface that is radially symmetric about a first axis;
an annular support over the first surface of the gripping disk, and having a substrate contact surface and a second surface, wherein a gap is formed between the first surface of the gripping disk and the second surface of the annular support;
an interception element having a lateral surface that mates with the first surface of the gripping disk, and a mating feature that is engaged with a portion of the gripping disk; and
one or more position adjustment devices that are in contact with the gripping disk and the support, wherein the position of the one or more position adjustment devices relative to the gripping disk is adjustable to adjust the size of the formed gap.

15. The handling device of claim 14, wherein the first surface has a wing shaped profile, so as to provide a laminar gas flow through the formed gap, and wherein the flow of gas is delivered from a gas source that is fluidly coupled to a seating region which is at least partially defined by the first surface of the gripping disk and surrounds at least a portion of the first axis.

16. The handling device of claim 15, wherein the wing shaped profile that has a portion of maximum convexity in correspondence with an intermediate diameter of the gripping disk, and additional portions that slope away from the maximum convexity portion towards a central part and towards a peripheral edge of the gripping disk.

17. The handling device of claim 14, wherein the first surface of the gripping disk has a wing shaped profile and the surface of the interception element has a curvilinear profile, which is configured to mate with at least a portion of the first surface, and the first surface of the gripping disk and the surface of the interception element are both symmetric about the first axis.

18. The handling device of claim 14, wherein the mating feature is constrained to move relative to the gripping disk in a first direction parallel to the first axis, and the handling device further comprises:
an elastic element disposed between the interception element and the gripping disk, and configured to supply a force to the gripping disk and the interception element that is proportional to the displacement of the interception element relative to the gripping disk along the first direction.
